(19) United States
(12) Patent Application Publication
(10) Pub. No.: US 2009/0226022 A1
(43) Pub. Date: Sep. 10, 2009

(54) Carrying Arrangement for Fastening a Headset for a Mobile Terminal at the User's Ear

(76) Inventors: Petteri Vairio, Kaarina (FI); Kari Hentunen, Aura (FI); Lea Sarasjoki, Helsinki (FI); Marja Helle, Turku (FI); Sami Lehtovaara, Masku (FI); Kalevi Salo, Salo (FI)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(21) Appl. No.: 12/085,886

(22) PCT Filed: Dec. 7, 2006
(86) PCT No.: PCT/IB2006/054650

§ 371 Date: May 7, 2009

(30) Foreign Application Priority Data
Dec. 15, 2005 (DE) 202005019729.7

(51) Int. Cl. H04R 25/00; A44B 21/00

(52) U.S. Cl. 381/370; 24/3.1; 24/3.12

(57) ABSTRACT

The invention relates to a carrying arrangement for fastening a headset for a mobile terminal to the user's ear. To allow a user wearing glasses to use a headset in a more comfortable way, a carrying arrangement for fastening a headset at the user's ear is provided, the carrying arrangement comprising the headset, a set of at least two ear fixing devices and at least one connecting system for the connection between the headset and the ear fixing devices, wherein the at least one connecting system is formed in such a way that each of the at least two ear fixing devices can be detachably mounted to the headset. Furthermore, the invention relates to a corresponding headset.

### CROSS REFERENCE TO RELATED APPLICATIONS

This application is the U.S. National Stage of International Application Number PCT/IB2006/054650 filed on Dec. 7, 2006 which was published in English on Jun. 21, 2007 under International Publication Number WO 2007/069147.

### TECHNICAL FIELD

The invention relates to a carrying arrangement for fastening a headset for a mobile terminal to the user's ear. Furthermore, the invention relates to a corresponding headset.

### BACKGROUND OF THE INVENTION

Headsets are used in many cases in which the continuous use of talk-listen devices is necessary or desired, for example, by telephone operators, persons providing directory assistance, air traffic controllers, persons handling telephone orders or persons carrying out assemblies in the field of manufacturing. In other words, headsets are used where the hands must be free during listening and speaking.

There are several possibilities known from the state of the art to fasten the headset at the user's ear. One way of fastening the headset is by placing a stirrup or hook connected to the headset around the pinna of the ear. This stirrup may be closed, for example ring-shaped, or the stirrup may be open toward the bottom. It is also possible that the stirrup is open to the front or to the rear, thereby allowing the user to slide on the headset from behind to the front. The latter is particularly suitable because of the natural shape of the human ear.

Headsets with a hook or stirrup to be fastened behind the user's ear can feel awkward to many users, especially if they wear eyeglasses or sunglasses. The headsets however require a reliable method for wearing them firmly such that users do not have to worry about dropping and loosing the headset.

There are also solutions known for wearing a headset, wherein the headset is fixedly connected to the temple of glasses, for example sunglasses.

There are numerous further design solutions in headsets for wearability. One is to press the headset to the ear so that a part of the headset penetrates the outer auditory canal. Another solution is to attach a pendable hook or stirrup that goes behind the ear lobe.

In contrast to for example hearing aids for hearing impaired people which are relatively small in size and weight, the problem of the known headsets is that users wearing glasses cannot fall back on one single solution which at the same time feels comfortable, fits firmly and is not required to be worn all the time as it is for example required when using the fixedly combined glasses and headset solution.

### SUMMARY OF THE INVENTION

It is an object of the invention to provide a carrying arrangement for fastening a headset to the user's ear which allows a user wearing glasses to use a headset in a more comfortable way.

According to a first aspect of the present invention a carrying arrangement for fastening a headset for a mobile terminal at the user's ear is provided, the carrying arrangement comprising the headset, a set of at least two ear fixing devices and at least one connecting system for the connection between the headset and the ear fixing devices, wherein the at least one connecting system is formed in such a way that each of the at least two ear fixing devices can be detachably mounted to the headset.

The carrying arrangement according to the present invention enables the end user to select the most comfortable carrying solution and to switch between different wearing methods of the headset without using any tools.

Furthermore, there is a new type of carrying solution offered which allows the user to individually fix the headset to glasses, especially eyeglasses or sunglasses. For example, the carrying arrangement according to the present invention allows the user to fix a headset to the temple of the user's glasses when wearing the glasses or to fasten the same headset to the user's ear via an earloop when not wearing glasses. As a matter of course, the user is also allowed to use all his glasses without a headset connected thereto.

According to another embodiment of the carrying arrangement of the present invention one single connecting system is provided, wherein the connecting system is formed in such a way that each of the at least two ear fixing devices can be detachably mounted to the headset by means of the single connecting system. Particularly, in this case the connecting system can be an integral part of the headset and/or of at least one of the at least two fixing devices. When using only one single connecting system the expenditure in manufacturing of such carrying arrangement, especially of the headset and/or the ear fixing devices, can be reduced.

Alternatively it is thinkable to provide the carrying arrangement with at least two connecting systems, wherein the connecting systems are formed in such a way that each of the at least two ear fixing devices can be detachably mounted to the headset by means of a corresponding one of the at least two connecting systems. In this case the at least two connecting systems can be an integral part of the headset and/or each of the at least two connecting systems can be an integral part of a corresponding one of the at least two ear fixing devices. The advantage of using more than one connecting system is that the single connecting systems can be formed as simple as possible, thereby increasing the reliability and the durability of the connecting system. Furthermore, the number of different ear fixing devices suitable for use with the carrying arrangement according to the present invention can be increased.

According to a further embodiment of the carrying arrangement of the present invention at least one of the at least two ear fixing devices is an earloop. The earloop for example comprises a hook or stirrup. Alternatively the earloop can comprise two arms. In this case, a very comfortable wearing solution is an earloop comprising two curved arms, each arm extending away from a first end portion to a second end portion, wherein the shape and orientation of the arms are symmetrical in relation to the longitudinal axes of the headset. Instead of using an earloop as one of the at least two ear fixing devices, it is also possible to use a temple of glasses, especially eyeglasses or sunglasses. According to the present invention there are also several further alternatives, for example at least one of the at least two ear fixing devices can be a device for penetrating the outer auditory canal of the user's ear.

According to another embodiment of the carrying arrangement of the present invention the connecting system is a snap-in locking device or part of a snap-in locking device. Alternatively the connecting system can be a clamping device or part of a clamping device. When using a clamping device, the clamping device may comprise an elastic loop or hook, especially made of metal. Such connecting systems are easy to use for everyone and do not require any tools for fixing the ear fixing devices to the headset.

In case of providing an elastic loop as clamping device it is thinkable that the loop is connected to the hook or to the arms of the earloop. Furthermore, such an elastic loop can be opened at one end, especially to the end the arms are connected to. Since the loop is elastic, especially when opened at one end, the headset can be easily connected to the respective one of the at least two ear fixing devices.

According to a second aspect of the present invention a headset, preferably for use with a carrying arrangement as described above, is provided, wherein the headset comprises at least one connection system for the connection between the headset and at least two ear fixing devices, wherein the at least one connecting system is formed in such a way that each of the at least two ear fixing devices can be detachably mounted to the headset.

The headset according to the present invention enables the end user to select the most comfortable carrying solution and to switch between different wearing methods of the headset without using any tools as already mentioned above.

According to another embodiment of the headset of the present invention one single connection system is provided, wherein the connecting system is formed in such a way that each of the at least two ear fixing devices can be detachably mounted to the headset. When using only one single connecting system the expenditure in manufacturing of such headset can be reduced.

Alternatively the headset can be provided with at least two connecting systems, wherein the connecting systems are formed in such a way that each of the at least two ear fixing devices can be detachably mounted to the headset. When using more than one connecting system the single connecting systems can be formed as simple as possible, thereby increasing the reliability and the durability of the headset. Furthermore, the number of different ear fixing devices suitable for being connected to the headset according to the present invention can be increased.

According to a further embodiment of the headset according to the present invention the connecting system is a snap-in locking device or part of a snap-in locking device. Alternatively the connecting system can be a clamping device or part of a clamping device. Such connecting systems are easy to use for everyone and do not require any tools for fixing the ear fixing devices to the headset.

### BRIEF DESCRIPTION OF THE DRAWINGS

The features of the present invention presented above as well as other features will now be described in greater detail with reference to the attached drawings, wherein:

FIG. 1 illustrates in a perspective view a carrying arrangement according to the present invention when used with a first one of several ear fixing devices;

FIG. 2 illustrates in a perspective view the carrying arrangement of FIG. 1 when used with a second one of the several ear fixing devices; and

FIG. 3 illustrates in a perspective view a headset according to the present invention.

### DETAILED DESCRIPTION OF THE DRAWINGS

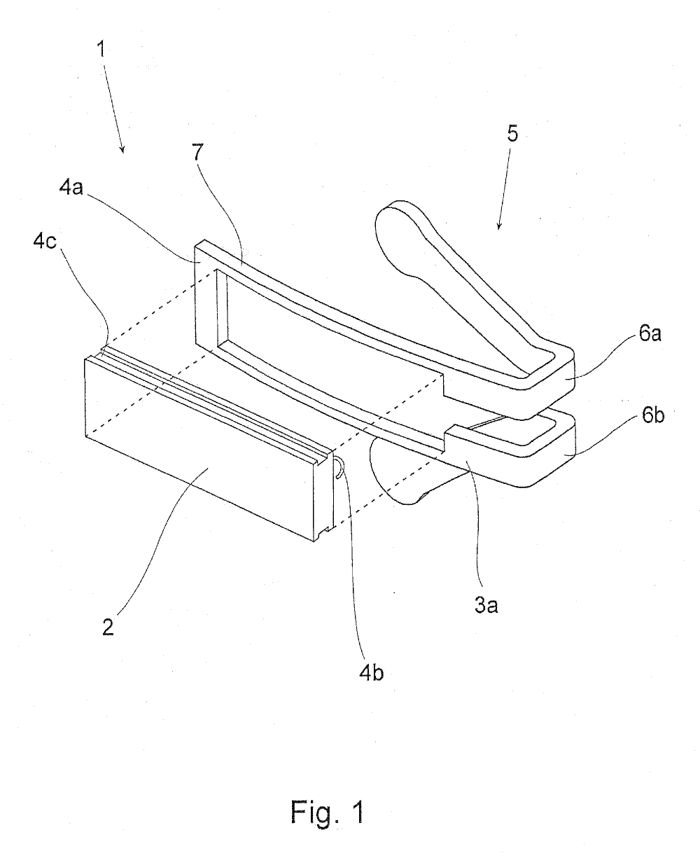

FIG. 1 illustrates a carrying arrangement 1 for fastening a headset 2 at the user's ear.

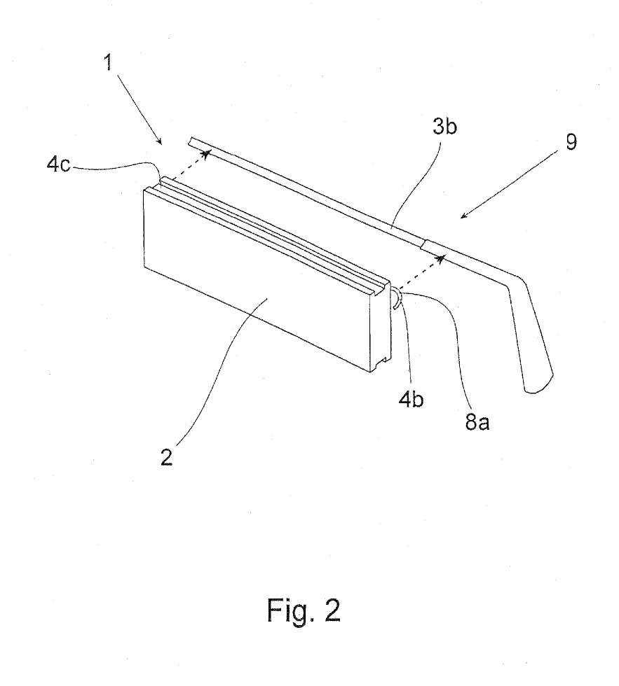

As shown in FIGS. 1 and 2, the carrying arrangement 1 comprises not only the headset 2, but also a set of two ear fixing devices 3a and 3b. The first ear fixing device 3a is an earloop 5 comprising two arms 6a and 6b, whereas the second ear fixing device 3b is the temple 9 of glasses (only the temple is shown).

Furthermore, the carrying arrangement 1 comprises several connecting systems 4a, 4b and 4c for the connection between the headset 2 and the respective one of the ear fixing devices 3a and 3b. The connecting systems 4a, 4b and 4c are all formed in such a way that each ear fixing device 3a and 3b can be detachably mounted to the headset 2.

As shown in FIG. 1, the connecting system 4a is an integral part of the ear fixing device 3a and the connecting system 4b and 4c are an integral part of the headset 2.

The connecting systems 4a and 4c are both part of the clamping device, wherein the clamping device comprises an elastic loop 7 which is connected to the arms 6a and 6b of the earloop 5, the loop 7 being opened at the end the arms 6a and 6b are connected to.

For fixing the headset 2 to the ear fixing device 3a the loop 7 as well as the arms 6a and 6b have to be moved slightly away from each other such that the headset 2 can be fitted inside the loop 7. When fitted together, the loop is partly placed inside recesses which form the connecting system 4c.

Furthermore, the headset 2 comprises a further connecting system 4b, the functionality of which is best shown in FIG. 2. The connecting system 4b comprises two hooks 8a which hooks 8a are made of an elastic material, in this special case of metal.

By means of these hooks 8a, which are integral part of the headset 2, the headset 2 can be fixed to the temple 9 of the user's glasses.

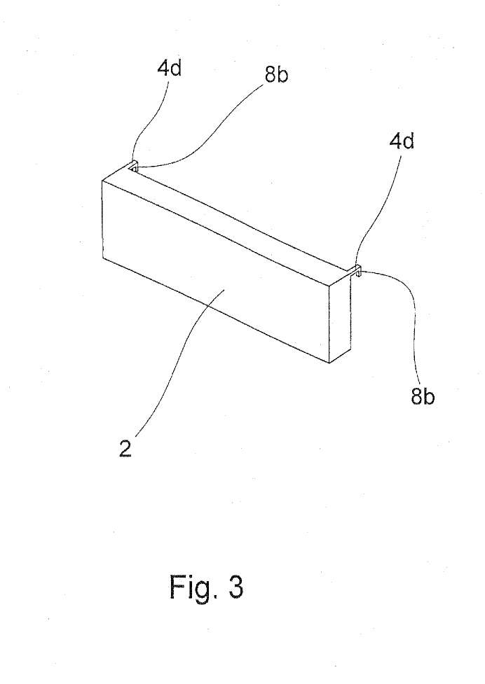

In contrast to the headset 2 used with the carrying arrangement shown in FIGS. 1 and 2, in FIG. 3 a headset 2 is shown which comprises one single connecting system 4d, wherein the connecting system 4d is formed in such a way that each of the ear fixing devices 3a and 3b shown in FIGS. 1 and 2 can be detachable mounted to the headset 2 of FIG. 3. In other words, the headset in FIG. 3 does not require a plurality of connecting systems, but only one single connecting system 4d, which single connecting system 4d however allows to fix the headset 2 to a plurality of ear fixing devices.

In the embodiment illustrated in FIG. 3 the single connecting system 4d comprises two hooks 8b which hooks 8b are formed in such a way that they fit around a part of the elastic loop 7 of the ear fixing device 3a shown in FIG. 1 as well as around the temple 9 of the ear fixing device 3b shown in FIG. 2.

While there have been shown and described and pointed out fundamental novel features of the invention as applied to preferred embodiments thereof, it will be understood that various omissions and substitutions and changes in the form and details of the devices and methods described may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto. Furthermore, in the claims means-plus-function clauses are intended to cover the structures described herein as performing the recited function and not only structural equivalents, but also equivalent structures. Thus although a nail and a screw may not be structural equivalents in that a nail employs a cylindrical surface to secure wooden parts together, whereas a screw employs a helical surface, in the environment of fastening wooden parts, a nail and a screw may be equivalent structures.

1. A carrying arrangement comprising:
a headset of a mobile terminal,
a set of at least two ear fixing devices and
at least one connecting system configured to provide a connection between the headset Hand the ear fixing devices, wherein the at least one connecting system is formed in such a way that each of the at least two ear fixing devices can be detachably mounted to the headset.

2. The carrying arrangement according to claim 1, wherein one single connecting system is provided, wherein the connecting system is formed in such a way that each of the at least two ear fixing devices can be detachably mounted to the headset by the single connecting system.

3. The carrying arrangement according to claim 2, wherein the connecting system is an integral part of the headset and/or of at least one of the at least two ear fixing devices.

4. The carrying arrangement according to claim 1, wherein at least two connecting systems are provided, wherein the connecting systems are formed in such a way that each of the at least two ear fixing devices can be detachably mounted to the headset by a corresponding one of the at least two connecting systems.

5. The carrying arrangement according to claim 4, wherein the at least two connecting systems are an integral part of the headset and/or each of the at least two connecting systems is an integral part of a corresponding one of the at least two ear fixing devices.

6. The carrying arrangement according to claim 1, wherein at least one of the at least two ear fixing devices is an earloop.

7. The carrying arrangement according to claim 6, wherein the earloop comprises a hook or stirrup.

8. The carrying arrangement according to claim 6, wherein the earloop comprises two arms.

9. The carrying arrangement according to claim 8, wherein the earloop comprises two curved arms, each arm extending away from a first end portion to a second end portion, wherein the shape and orientation of the arms are symmetrical in relation to the longitudinal axis of the headset.

10. The carrying arrangement according to claim 1, wherein at least one of the at least two ear fixing devices is a temple of glasses.

11. The carrying arrangement according to claim 1, wherein at least one of the at least two ear fixing devices is a device configured to penetrate the outer auditory canal of the user's ear.

12. The carrying arrangement according to claim 1, wherein the connecting system is a snap-in locking device or part of a snap-in locking device.

13. The carrying arrangement according to claim 1, wherein the connecting system is a clamping device or part of a clamping device.

14. The carrying arrangement according to claim 13, wherein the clamping device comprises an elastic loop or hook, especially made of metal.

15. The carrying arrangement according to claim 14, wherein the loop is connected to the hook or to the arms of the earloop.

16. The carrying arrangement according to claim 14, wherein the loop is opened at one end, especially to the end the arms are connected to.

17. A headset of a mobile terminal, comprising at least one connecting system configured to provide a connection between the headset and at least two ear fixing devices, wherein the at least one connecting system is formed in such a way that each of the at least two ear fixing devices can be detachably mounted to the headset.

18. The headset according to claim 17, wherein one single connecting system is provided, wherein the connecting system is formed in such a way that each of the at least two ear fixing devices can be detachably mounted to the headset.

19. The headset according to claim 17, wherein at least two connecting systems are provided, wherein the connecting systems are formed in such a way that each of the at least two ear fixing devices can be detachably mounted to the headset.

20. The headset according to claim 17, wherein the connecting system is a snap-in locking device or part of a snap-in locking device.

21. The headset according to claim 17, wherein the connecting system is a clamping device or part of a clamping device.

22. A headset of a mobile terminal comprising at least two ear fixing devices, and means for providing a connection between the headset and the at least two ear fixing devices, so that each of the at least two ear fixing devices can be detachably mounted to the headset.
